(19) United States
(12) Patent Application Publication
(10) Pub. No.: US 2025/0172102 A1
(43) Pub. Date: May 29, 2025

(54) SYSTEMS AND METHODS FOR MATCHING OF TORQUE CONVERTERS WITH ENGINE PLATFORMS

(71) Applicant: CUMMINS INC., Columbus, IN (US)

(72) Inventor: Steven M. Bellinger, Columbus, IN (US)

(73) Assignee: Cummins Inc., Columbus, IN (US)

(21) Appl. No.: 18/961,382

(22) Filed: Nov. 26, 2024

Related U.S. Application Data
(60) Provisional application No. 63/603,823, filed on Nov. 29, 2023.

(51) Int. Cl. F02D 41/02

(52) U.S. Cl. CPC F02D 41/0215; F02D 2200/101; F02D 2250/26; F02D 2400/12

(57) ABSTRACT

Systems and methods for improving torque converter matching can include a controller monitoring a state of a torque converter of a vehicle and controlling the engine torque based on the state of the torque converter. The controller can dynamically control the engine torque, when the torque converter is determined to be in an open state, to maintain substantially constant engine power or to regulate the engine torque as a function of the speed ratio of the torque converter, such as over a full spectrum of the speed ratio. The controller can cause the engine to operate according to different engine torque curves or patterns at different states of the torque converter.

### CROSS-REFERENCE TO RELATED PATENT APPLICATION

This application claims the benefit of and priority to U.S. Provisional Application No. 63/603,823, filed on Nov. 29, 2023, which is incorporated herein incorporated by reference in its entirety and for all purposes.

### TECHNICAL FIELD

The present disclosure relates to integrating engine platforms with torque converters. More specifically, the present disclosure relates to systems and methods for matching torque converters with reduced governed speed engine ratings.

### BACKGROUND

A torque converter is employed in automatic transmission vehicles, and it enables automatic transmission to work. The torque converter is integrated or arranged between the engine and transmission of a vehicle and transmits that torque from the engine to a rotating driven load. The torque converters can be viewed as providing fluid coupling or mechanical coupling depending on the state of the torque converter. The torque converter usually includes an impeller, a turbine, a stator, a clutch, and fluid.

The impeller includes a plurality of blades and is mechanically coupled to the engine. As the engine rotates, the impeller spins with similar speed pushing transmission fluid through its blades. The torque converter can operate in open or closed states. When the torque converter is in closed state, the impeller is mechanically coupled to the turbine. However, in the open state, a varying fluid coupling occurs between the impeller and the turbine.

As the speed of the impeller increases, the fluid leaves the impeller and moves into the turbine causing the turbine to begin turning, which turns the transmission shaft and pump in the vehicle. The fluid is redirected through the center of the turbine to hit the impeller again. The stator is located in the center of the torque converter and is structured to keep the transmission fluid from hitting the converter housing and slowing it down.

### SUMMARY

One embodiment relates to a method. The method includes: monitoring, by a processor, a state of a torque converter of a vehicle; and dynamically controlling, by the processor, an output torque of an engine of the vehicle when the torque converter is in an open state, such that the output torque of the engine at a predefined speed ratio of the torque converter is smaller than or equal to a maximum torque allowed by the torque converter at the predefined speed ratio.

Another embodiment relates to a system. The system includes a controller including one or more processors and a memory storing executable instructions. The executable instructions, when executed by the one or more processors, cause the controller to: monitor a state of a torque converter of a vehicle; and control an output torque of an engine of the vehicle, when the torque converter is in an open state, such that the output torque of the engine at a predefined speed ratio of the torque converter is smaller than or equal to a maximum torque allowed by the torque converter at the predefined speed ratio.

Still another embodiment relates to a method. The method includes: monitoring, by a processor, a state of a torque converter of a vehicle; controlling, by the processor, an output torque of an engine of the vehicle according to a first torque pattern when the torque converter is in an open state; and controlling, by the processor, the output torque of the engine of the vehicle according to a second torque pattern when the torque converter is in closed state, the second torque pattern is different from the first torque pattern.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a schematic diagram of a vehicle, according to an example embodiment.

FIG. 2 depicts example torque absorption curves of a torque converter of a given type and a plurality torque curves for various engines.

FIG. 3 is a schematic diagram of a controller of the vehicle of FIG. 1, according to example embodiments.

FIG. 4 is a flow diagram illustrating a method of dynamically controlling engine torque to achieve better torque converter matching, according to an example embodiment.

FIG. 5 depicts example engine torque curves of a dynamically controlled engine, according to an example embodiment.

FIG. 6 is a flow diagram of another method for controlling engine torque to achieve better torque converter matching, according to an example embodiment.

### DETAILED DESCRIPTION

In vehicles having automatic transmission, integrating an engine of a given engine rating or engine platform with an automatic transmission system involves selecting a matching torque converter to be integrated between the engine and the automatic transmission system. Specifically, suppliers or manufacturers of automatic transmission systems impose certain limits on the amount of torque to be fed to their transmission system from the engine. A matching torque converter is a one that can absorb enough engine torque so that the final torque fed to the transmission system meets the transmission system requirements.

In conventional torque converter matching, the transmission system supplier or provider can require the torque converter to absorb full engine torque at 0.8 speed ratio (SR) for engine speed smaller than or equal to the governed engine speed. The governed engine speed is specified by the engine manufacturer. The governed engine speed is typically defined or specified as the maximum engine speed an engine is capable of producing at its rated or advertised power. The engine manufacturer can specify the governed speed based on environmental and/or regulatory requirements. The 0.8 SR constraint implies that the torque converter will be operating at the 0.8 SR when the engine speed is less than or equal to the governed speed. In other words, if the 0.8 SR constraint is not satisfied, the torque converter will be operating at a speed ratio less than 0.8 at governed speed of the engine. In such case, the torque converter will be absorbing less torque than it should at governed speed leading to higher oil shear, reduced converter efficiency and increased heat. Also, operating at a reduced speed ratio leads to a higher speed difference when the torque converter switches from the open state to the closed or lock state. For instance, operating at 0.7 SR instead of 0.8 SR leads to an increase in the engine speed difference from 200 revolutions per minute (rpm) to 300 rpm at an engine speed of 1000 rpm. The higher the speed difference, the harsher or jerkier the switching event will be felt by the driver and/or other individuals in the vehicle.

Engine manufacturers typically design their engine to operate according to a single torque pattern or curve regardless of the state of the converter. In other words, the engine produces the same amount of torque at a given engine speed regardless of whether the torque converter is in an open state or in a closed or lock state. This approach, however, can lead to heavy converter matches for engines designed with low governed speeds. In particular, for engine platforms with reduced governed speeds, the 0.8 SR torque constraint or limit results in heavy converter matches (e.g., matched torque converter with relatively high torque absorption) especially for high horsepower (HHP) engine ratings. However, heavier torque converter matches are generally undesirable for various reasons. First, a heavier torque converter (e.g., with higher torque absorption) increases an engine's curb idle torque, which in turn leads to higher greenhouse gas emission during stationary, in gear, idle events. Also, the heavier torque converters generally have lower stall torque ratios reducing stall gradeability and degrading off-idle acceleration (lug-up) performance.

Systems, devices, and methods described herein provide more optimal solutions to the technical problem of torque converter matching by dynamically controlling the output torque of the engine based on the state and/or other parameters of the torque converter during open converter operation to facilitate the use of more traditional torque converter matches. A first approach would be to control the engine according to different torque curves or torque patterns depending on the state of the torque converter. For instance, a controller or an electronic control unit (ECU), also referred to herein as electronic control module (ECM), can control the output torque of the engine according to a first torque curve or pattern when the torque converter is in an open state, and control the output torque of the engine according to a second torque curve or pattern when the torque converter is in a closed or locked state. Another approach would be to control the engine to a constant power that while satisfying the 0.8 SR requirement when the torque converter is an open state. A third approach would be to dynamically regulate the output torque of the engine across the full SR spectrum of the torque converter.

In general, the systems, devices and methods described herein improve torque converter matching by satisfying torque limits or constraints with relatively lighter (e.g., with relatively lower torque absorption) torque converters. The systems, devices and methods described herein also provide enhanced fuel efficiency, reduced greenhouse gas emission during stationary, in gear, idle events, increased stall gradeability, enhanced off-idle acceleration performance and improved driving experience. To satisfy torque constraints or requirements specified by transmission system providers, engines designed with reduced governed speeds can be integrated with heavier converter matches or may follow competitive torque curve shaping practices. Both of these options are not desirable because they lead to increased curb idle torque, reduced stall gradeability, degraded off-idle acceleration performance and/or poor driving experience. However, the systems, devices and methods described herein make the use of more traditional converter matches possible, and therefore, enable the HHD engine platform to deliver class leading levels of driveability and efficiency in spite of the significant reduction in governed engine speed.

Referring to the figures generally, systems and methods of matching torque converters with engine ratings, such as reduced governed speed engine ratings, are described herein. A vehicle controller, e.g., an electronic control unit (ECU), can monitor a state of the torque converter of the vehicle and dynamically control the engine torque when the torque converter is determined to be in an open state. Dynamically controlling the engine torque may include the controller controlling the engine to maintain substantially constant engine power. Dynamically controlling the engine torque may include the controller regulating the engine torque as a function of the SR of the torque converter, e.g., over a full spectrum of the SR. In some embodiments, the vehicle or transmission controller can monitor the state of the torque converter and cause the engine to operate according to different engine torque curves or patterns at different states of the torque converter. In particular, the controller can cause the engine to operate according to a first engine torque curve (or first engine torque pattern) when the torque converter is in open state, and cause the engine to operate according to a second engine torque curve (or second engine torque pattern) when the torque converter is in closed or locked state, wherein the first engine torque curve/pattern is different from the first engine torque curve/pattern.

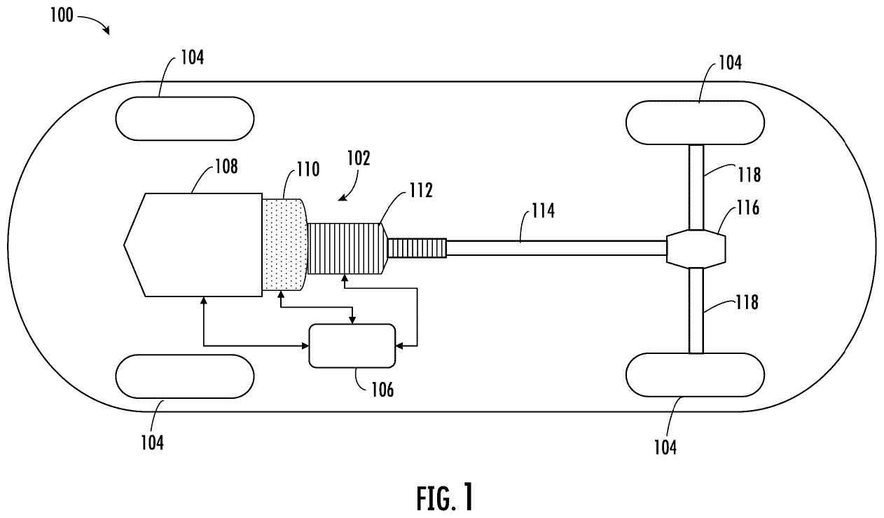

Referring to FIG. 1, a schematic diagram of a vehicle 100 is shown, according to example embodiments. The vehicle 100 may be an on-road or an off-road vehicle including, but not limited to, a semi-trailer truck, an extra-duty truck, an 18-wheeler truck, a tanker truck, a heavy truck, a flatbed truck, a line-haul truck, a mid-range truck (e.g., pick-up truck), a garbage truck, a dump truck, a panel truck, a car, a sport utility vehicle (SUV), a bus, a mini-bus, a tank or any other type of vehicle with automatic transmission. The vehicle 100 can include a powertrain 102 a set of wheels 104 and a controller 106. The powertrain 102 can include an engine 108, a torque converter 110, a transmission system 112, a driveshaft 114, a differential 116, and pair of axles 118.

The engine 108 uses fuel to generate mechanical energy or torque. The torque output by the engine 108 is fed to the transmission system 112 via the torque converter 110. The transmission system 112 (also referred to herein as automatic transmission system 112) can automatically change gears based on car speed and accelerator input (e.g., position of the gas pedal of the vehicle 100) so that the engine speed is kept appropriately low. Specifically, the transmission system 112 can sense the change in engine speed and in response change gears in the planetary gearset. The torque or mechanical energy output by the transmission system 112 is transferred to the some (e.g., rear wheels) or all of the wheels 104 via the driveshaft 114, the differential 116, and the axles 118.

The torque converter 110 provides fluid or hydraulic coupling between the engine 108 and the transmission system 112. The torque converter 110 can operate in two different states referred to herein as an open state and a closed or locked state. In the open state, the torque converter operates as a fluid coupler between the engine 108 and the transmission system 112 and the engine torque is not fully transferred to the transmission system 112. The open state can be viewed as including two phases referred to herein as stall (or a stall phase) and an acceleration phase. During stall, the engine 108 is turning but the vehicle 100 is idle (not moving). A stall event occurs when the engine 108 is running, the transmission system 112 is in gear and the brake pedal is pressed preventing the vehicle 100 from moving. During stall, the impeller of the torque converter 110 is turning but the turbine of the torque converter 110 is not turning. As such, none of the engine torque is transferred to the transmission system 112. In the acceleration phase, the speed of the impeller is partially transferred to the turbine via the fluid coupling between the two components in the torque converter 110. Accordingly, the engine torque is partially transferred to the transmission system.

The open state of the torque converter 110 can also be viewed as a continuum of speed ratios (SRs). The speed ratio (SR) represents the ratio of the impeller speed or engine speed that is transferred to the turbine or to the transmission system 112. For instance, a 0.5 SR implies that half of the engine speed is transferred to the transmission system 112. For example, if the engine speed is 1000 rpm, the turbine speed or transmission system speed will be 500 rpm when the torque converter 110 is operating at 0.5 SR. The SR defined the amount of torque absorbed by the torque converter. For example, at 0.0 SR, the engine torque is fully absorbed by the torque converter. At 0.5 SR, half of the engine torque is absorbed by the torque converter 110 while the other half is transferred to the transmission system 112.

In the closed (or locked) state, the turbine of the torque converter 110 is fully coupled to the impeller. For instance, the torque converter 110 can have a lock clutch designed or configured to mechanically lock or couple the turbine to the impeller leading to a mechanical coupling between both components. In the closed (or locked) state, the impeller speed or engine speed is equal to the turbine speed or to the transmission system speed.

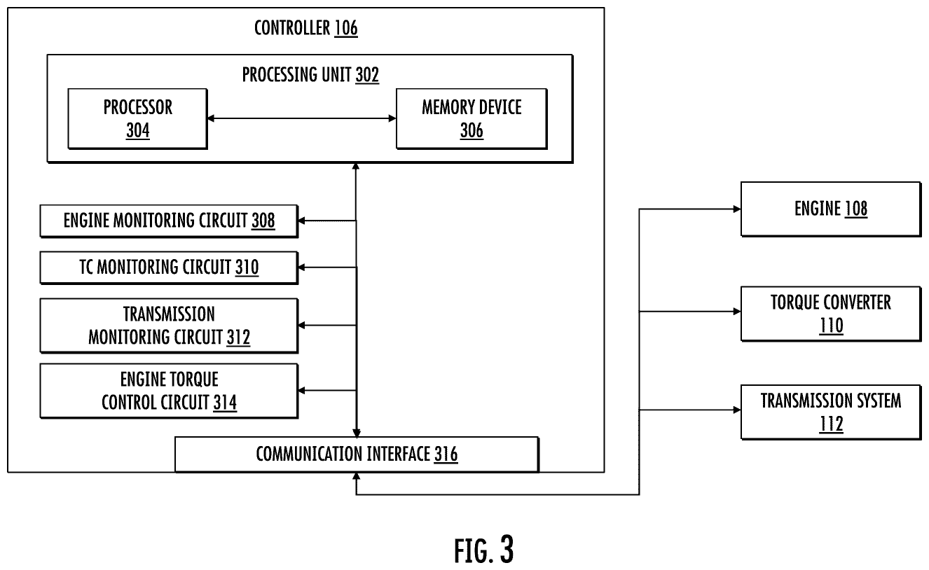

The controller 106 can include an engine control module or unit (ECM or ECU), a powertrain control module, a transmission control module, an aftertreatment system control module and/or a combination thereof. The controller 106 can be communicatively coupled to the engine 108, the torque converter 110, the transmission system 112 and/or other components or systems of the vehicle 100. In general, the controller 106 is communicatively coupled to systems and components of the vehicle 100 and is structured to acquire operation data and/or on-board diagnostics (OBD) capability data regarding one or more of the components or systems shown in FIG. 1. For example, the operation data may include data regarding operating conditions of the engine 108, the torque converter 110 and/or the transmission system 112 acquired by one or more sensors. A more detailed description of the controller 106 is provided below in relation with FIG. 3.

Communication between and among the components may be via any number of wired or wireless connections. For example, a wired connection may include a serial cable, a fiber optic cable, a CAT5 cable, or any other form of wired connection. In some implementations, a controller area network (CAN) bus provides the exchange of signals, information, and/or data. The CAN bus can include any number of wired and wireless connections. The controller 106 can receive data from one or more of the components shown in FIG. 1, and/or transmit instructions, commands or data to one or more of the components shown in FIG. 1. For instance, the controller 106 may receive data or measurements from one or more sensors attached to or associated with the engine 108 such as a speed sensor or a torque sensor, one or more sensors attached to or associated with the torque converter 110, such as a speed sensor of the impeller, a speed senor of the turbine and/or a clutch sensor, and/or one or more sensors attached to or associated with the transmission such as a gear sensor.

In some embodiments, the engine 108 can be any type of internal combustion engine. The engine 108 can be fueled by gasoline, natural gas, hydrogen, propane, diesel fuel, or another type of fuel. In some embodiments, the engine 108 can be a part of a hybrid engine system (e.g., a combination of an internal combustion engine and one or more electric motors). In some embodiments, the engine 108 can be configured as a spark-ignition (SI) or a compression-ignition (CI) engine.

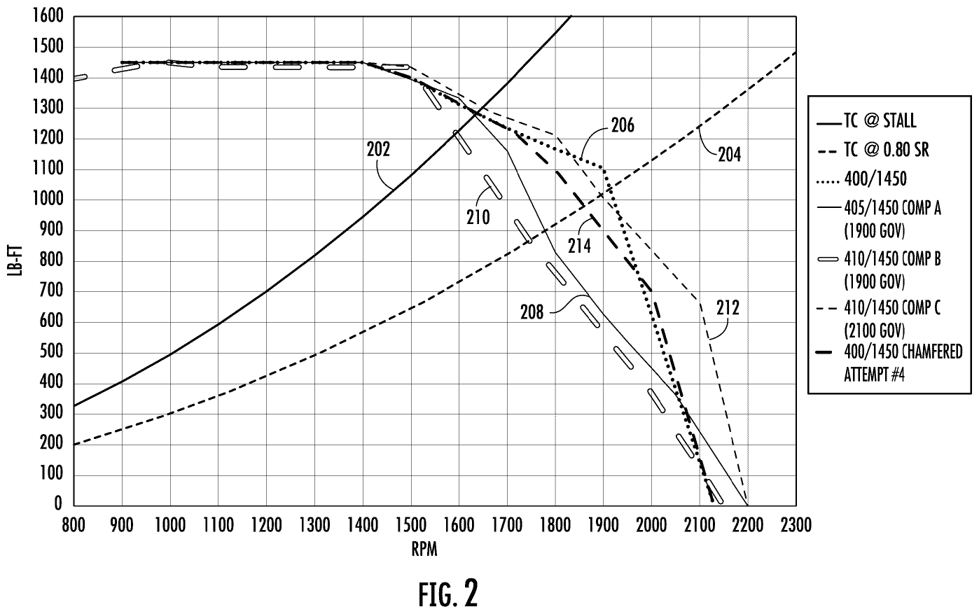

Referring now to FIG. 2, example torque absorption curves of a torque converter and various engine torque curves for a plurality of engines are depicted. Curve 202 represents the torque absorption curve of a torque converter of a given type at 0 speed ratio. The x-axis represents the engine rotation speed in rpm. Curve 202 is also referred to herein as the absorption curve at stall. Curve 204 represents the absorption curve, e.g., as a function of engine rotation speed, of the torque converter at 0.8 speed ratio. It is to be noted that the SR as used herein represents the ratio of the turbine speed (or output speed of the torque converter 110) relative to the engine speed (or output speed of the torque converter 110) when the torque converter is in the open state. For example, a 0.95 SR means that if the engine 108 is operating at 1000 RPM or the input speed is 1000, then the output speed or turbine speed is going to be 950 rpm. At stall or 0 SR, the output speed of the torque converter is zero regardless of the engine speed. The stall can occur when the automatic transmission is in drive and the brake pedal is depressed. Because the engine 108 is running, the engine 108 rotates and so does the impeller, but there is no rotation of the turbine or at the output of the torque converter. As the accelerator pedal (or gas pedal) is simultaneously depressed more and more, while the brake pedal is still depressed, the engine torque will increase, and more torque will be absorbed by the torque converter 110. The increase in the torque absorption as the engine speed (or input speed of the torque converter 110) increases is depicted by the monotonic characteristic of curve 202.

While FIG. 2 shows the torque absorption curves at 0 and 0.8 speed ratios, only, each torque converter has a separate torque absorption curve at each SR value. Each torque absorption curve is defined by a corresponding K-factor. For instance, at a given SR, the torque absorption function of the torque converter can be defined as τ=(speed/K_{SR})², where the speed is expressed in rpm and K_{SR} represents the K-factor at the SR. The focus here is on the torque absorption curves 202 and 204 at 0 SR and 0.8 SR, respectively, because it is common for providers or suppliers of the transmission system 112 to specify requirements or criteria at stall and 0.8 SR for the torque converters that can be paired with a given engine rating (or engine type) that is used with their transmission system. In particular, at 0.8 SR, the requirement or criterion is that the torque converter 110 should absorb all the engine torque at or below governed speed. In other words, the engine torque produced at governed speed should not exceed the torque absorption of (or the torque absorbed by) the torque converter 110 at the engine governed speed. Another criterion is usually specified for 0 SR or stall. It is common for providers or suppliers of the transmission system 112 to specify an additional criterion for 0 SR or stall.

Curves 206-214 represent engine torque curves (or output torque curves) for various engine ratings or engine types. For instance, curve 206 represents the engine torque of an engine having a 400 horsepower, a maximum torque of 1450 pound foot and a governed speed of 1900 rpm. At the governed speed of 1900 rpm, the curve 206 has a corresponding torque that is greater than the torque absorbed by the torque converter at 0.8 SR (shown by curve 204). Therefore, the pairing or matching of the torque converter with the engine corresponding to the torque curve 206 fails the matching criterion at 0.8 SR. In other words, a torque converter with higher torque absorption would be used with the engine corresponding to the torque curve 206.

Torque curve 208 represents the torque generated by another engine (e.g., of a competitor A) having a 405 horsepower, a maximum torque of 1450 pound foot and a governed speed of 1900 rpm. At the governed speed of 1900 rpm, the torque generated by the engine of competitor A is below the absorption torque of the torque converter at 0.8 SR (shown by curve 204). Also, torque curve 210 represents the torque generated by a third engine (e.g., of a competitor B) having a 410 horsepower, a maximum torque of 1450 pound foot and a governed speed of 1900 rpm. At the governed speed of 1900 rpm, the torque generated by the engine of competitor B is also below the absorption torque of the torque converter at 0.8 SR (shown by curve 204). Both engines of competitors A and B satisfy the matching criterion at 0.8 SR.

Torque curve 212 represents the torque generated by a fourth engine (e.g., of a competitor C) having a 410 horsepower, a maximum torque of 1450 pound foot and a governed speed of 2100 rpm. At the governed speed of 2100 rpm, the torque generated by the engine of competitor C is below the absorption torque of the torque converter at 0.8 SR (shown by curve 204). Also, the torque curve 214 represents the torque generated by a fifth engine (referred to as Chamfered attempt #4 in FIG. 2) having a 400 horsepower, a maximum torque of 1450 pound foot and a governed speed of 2000 rpm. At the governed speed of 2000 rpm, the torque generated by the fifth engine depicted by curve 214 is below the absorption torque of the torque converter at 0.8 SR (shown by curve 204). Both engines of corresponding to curves 212 and 214 satisfy the matching criterion at 0.8 SR.

Each of the engines corresponding to the torque curves 206-214 is typically designed to generate torque according to the corresponding torque curve. In particular, the engine produces torque as a function of the engine speed independent of the state or parameters of the torque converter. In other words, engine manufacturers may design and make their engines 108 to operate according to a predefined torque curve (or torque pattern) and then a matching torque converter 110 that satisfies the matching criteria, e.g., at stall and 0.8 SR, is determined. This approach, however, comes with limitations. For instance, competitors A and B apply the Chamfered approach to cause corresponding torque curves 208 and 210 to exhibit a sharp decrease in engine torque as the engine speed gets close to the governed speed. For example, both torque curves 208 and 210 exhibit a sharp torque decrease starting from the engine speed of about 1500 rpm. This approach leads to a relatively low torque at the governed speed, e.g., 1900 rpm, to satisfy the matching criterion of some torque converter 110 at 0.8 SR.

To guarantee or attempt to guarantee satisfying the matching criteria for traditional low absorbing torque converters, especially the matching criterion at 0.8 SR, suppliers of the engines corresponding to torque curves 212 and 214 designed their engines to have torque curves with relatively higher governed speed, e.g., compared to competitors A and B, and a sharp drop or decrease in engine torque that starts at relatively higher engine speed compared to competitors A and B. As a result, the engines corresponding to the torque curves 212 and 214 produce more torque at 1900 rpm compared to the engines corresponding to torques curves 208 and 210. However, the approach of increasing the governed speed can lead to emission challenges. Furthermore, with regard to competitors A and B, the corresponding engines produce much less torque than what is allowed at the governed speed of 1900 rpm.

It is to be noted that in vehicles 100 using automatic transmission, it is desired to close the torque converter clutch (or switch the torque converter 110 to the closed state) as quickly as possible because the longer the torque converter 110 is in the open state the more torque it absorbs and the more heat it generates. If at the time of closing the clutch the torque converter 110 is operating at 0.8 SR and it takes a time duration t to close the clutch, the engine speed will decrease by 20% within the time duration t. However, if at the time of closing the clutch the torque converter 110 is operating at 0.7 SR, the engine speed will decrease by 30% within the time duration t as the clutch closes. The higher decreasing rate in engine speed leads to more jerk and harsher clutch closing events due to a fair amount of inertia in the engine itself. For example, if the engine is running at 1000 rpm at the time of closing the clutch, the engine speed will decrease by 200 rpm with the time duration t if the torque converter is operating at 0.8 SR at the closing time. However, the engine speed will decrease by 300 rpm with the time duration t if the torque converter is operating at 0.7 SR at the closing time.

In the current disclosure, systems and methods for controlling the engine torque dynamically or based on the state of the torque converter are described to address the above discussed technical problems. In particular, the approach of notching or shaping the engine torque curves to specifically enable the use of more traditional torque converters adopted by many engine suppliers leads to compromised driveability of the vehicle 100 at high speeds and loads once the torque converter closes due to the shape of the notched engine torque curves. The systems and methods described employ dynamic controlling of the engine torque and/or different torque patterns depending on the state of the torque converter 110 to enable better torque converter matching, more efficiency and enhanced driving experience.

Referring now to FIG. 3, a schematic diagram of the controller 106 of the vehicle 100 of FIG. 1 is shown according to an example embodiment. As shown in FIG. 3, the controller 106 includes a processing circuit 302 having a processor 304 and a memory device 306, an engine monitoring circuit 308, a torque converter monitoring circuit 310, a transmission monitoring circuit 312, an engine torque control circuit 314 and a communications interface 316. The controller 106 can be structured to monitor operating parameters of the torque converter 110 and control the torque produced by the engine 108 based on the operating parameters of the torque converter 110. In some implementations, the controller 106 can receive information indicative of the state (or state switching) of the torque converter 110 and/or torque converter speed ratio from the torque converter 110 or one or more sensors thereof, and control the torque produced by the engine 108 dynamically or using different torque curves (or torque patterns) for different states of the torque converter 110. The controller can control the engine torque by controlling fuel flow to the engine 108.

In one configuration, the engine monitoring circuit 308, the torque converter monitoring circuit 310, the transmission monitoring circuit 312 and/or the engine torque control circuit 314 can be embodied as machine or computer-readable media storing instructions that is executable by a processor, such as the processor 304. As described herein and amongst other uses, the machine-readable media facilitates performance of certain operations to enable reception and transmission of data. For example, the machine-readable media may provide an instruction (e.g., command) to, e.g., acquire data. In this regard, the machine-readable media may include programmable logic that defines the frequency of acquisition of the data (or, transmission of the data). The computer-readable media may include code, which may be written in any programming language including but not limited to Java or the like and any conventional procedural programming languages, such as the “C” programming language or similar programming languages. The computer-readable program code may be executed on one processor or multiple remote processors. In the latter scenario, the remote processors may be connected to each other through any type of network (e.g., CAN bus).

In another configuration, the engine monitoring circuit 308, the torque converter monitoring circuit 310, the transmission monitoring circuit 312 and/or the engine torque control circuit 314 may be embodied as one or more circuitry components including, but not limited to, comparators, processing circuitry, network interfaces, peripheral devices, input devices, output devices, etc. In some implementations, the engine monitoring circuit 308, the torque converter monitoring circuit 310, the transmission monitoring circuit 312 and/or the engine torque control circuit 314 may take the form of one or more analog circuits, electronic circuits (e.g., integrated circuits (IC), discrete circuits, system on a chip (SOC) circuits, microcontrollers), telecommunication circuits, hybrid circuits, and any other type of circuit. In this regard, the engine monitoring circuit 308, the torque converter monitoring circuit 310, the transmission monitoring circuit 312 and/or the engine torque control circuit 314 may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on). The engine monitoring circuit 308, the torque converter monitoring circuit 310, the transmission monitoring circuit 312 and/or the engine torque control circuit 314 may also include programmable hardware devices such as field programmable gate arrays, programmable array logic, programmable logic devices or the like. The engine monitoring circuit 308, the torque converter monitoring circuit 310, the transmission monitoring circuit 312 and/or the engine torque control circuit 314 may include one or more memory devices for storing instructions that are executable by the processor(s) of the engine monitoring circuit 308, the torque converter monitoring circuit 310, the transmission monitoring circuit 312 and/or the engine torque control circuit 314. The one or more memory devices and processor(s) may have the same definition as provided below with respect to the memory device 306 and the processor 304. In some hardware unit configurations, the engine monitoring circuit 308, the torque converter monitoring circuit 310, the transmission monitoring circuit 312 and/or the engine torque control circuit 314 may be geographically dispersed throughout separate locations in the vehicle 100. Alternatively, the engine monitoring circuit 308, the torque converter monitoring circuit 310, the transmission monitoring circuit 312 and/or the engine torque control circuit 314 may be embodied in or within a single unit/housing, which is shown as the controller 106.

In the example shown, the controller 106 includes the processing circuit 302 having the processor 304 and the memory device 306. The processing circuit 302 may be structured or configured to execute or implement the instructions, commands, and/or control processes described herein with respect to the engine monitoring circuit 308, the torque converter monitoring circuit 310, the transmission monitoring circuit 312 and/or the engine torque control circuit 314, or to execute instructions stored in the memory device 306. The depicted configuration represents the engine monitoring circuit 308, the torque converter monitoring circuit 310, the transmission monitoring circuit 312 and/or the engine torque control circuit 314 as a machine or a computer-readable medium. However, as mentioned above, this illustration is not meant to be limiting as the present disclosure contemplates other embodiments where the engine monitoring circuit 308, the torque converter monitoring circuit 310, the transmission monitoring circuit 312 and/or the engine torque control circuit 314, or at least a component thereof, is configured as a hardware unit. All such combinations and variations are intended to fall within the scope of the present disclosure.

The processor 304 may be implemented or performed with a single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some implementations, the one or more processors may be shared by multiple circuits (e.g., the engine monitoring circuit 308, the torque converter monitoring circuit 310, the transmission monitoring circuit 312 and/or the engine torque control circuit 314 or components thereof may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example implementations, two or more processors may be coupled via a bus to enable independent, parallel, pipelined, or multi-threaded instruction execution. All such variations are intended to fall within the scope of the present disclosure.

The memory device 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 306 may be communicably connected to the processor 304 to provide computer code or instructions to the processor 304 for executing at least some of the processes described herein. Moreover, the memory device 306 may be or include tangible, non-transient volatile memory or non-volatile memory. Accordingly, the memory device 306 may include database components, object code components, script components, or any other type of information structure for supporting the various activities and information structures described herein.

The communications interface 316 can be a circuit that enables the controller 106 to communicate with other devices or systems in the vehicle 100. For instance, the communications interface 316 can receive signals indicative of engine from a speed sensor of the engine 108, signals indicative of a state of the torque converter from a clutch sensor, indications of speed ratios from the torque converter 110 or a sensor thereof, other sensor measurements or a combination thereof. The communications interface 316 can be coupled to various external systems such as the engine 108 and/or sensors or components thereof. For example, the communications interface 316 can be coupled to a speed sensor of the engine 108 and/or the throttle of the engine 108. The communications interface 316 can be coupled to the torque converter 110 and/or sensors thereof. For example, the communications interface 316 can be coupled to a clutch sensor, an impeller speed sensor and/or a turbine speed sensor of the torque converter 110. The communications interface 316 can be coupled to the transmission system 112 and/or sensors thereof.

The communications interface 316 can include a plurality of communication ports. For example, each communication port can be coupled to a respective external system of the plurality of external systems. For example, the communications interface 316 can include a communication port coupled to the speed sensor of the engine 108, a communication port coupled to the throttle of the engine 108, a communication port connected to the clutch sensor of torque converter 110, a communication port coupled to the impeller speed sensor, a communication port coupled to the turbine speed sensor and/or a communication port coupled to the transmission system 112. In some implementations, the communications interface 316 can include one or more communication ports coupled to the load/weight sensor and the driving slop sensor. In some implementations, the communications interface 316 can include a single port coupled to all the external systems.

In this regard, components of the vehicle 100 may communicate with each other or foreign components (e.g., a remote operator) using any type and any number of wired or wireless connections. Communication between and among the controller 106 via the communications interface 316 and the components of the vehicle 100 may be via any number of wired or wireless connections (e.g., any standard under IEEE 802). For example, a wired connection may include a serial cable, a fiber optic cable, a CAT5 cable, or any other form of wired connection. Wireless connections may include the Internet, Wi-Fi, cellular, radio, Bluetooth, ZigBee, etc. In one embodiment, a controller area network (CAN) bus provides the exchange of signals, information, and/or data. The CAN bus includes any number of wired and wireless connections that provide the exchange of signals, information, and/or data. The CAN bus may include a local area network (LAN), or a wide area network (WAN), or the connection may be made to an external computer (for example, through the Internet using an Internet Service Provider).

The external systems can include a dashboard of the vehicle 100. The controller 106 can send a signal indicative of engine speed to the dashboard (or a respective display device) of the vehicle 100. The external systems can include a remote device, such as a computer server. The controller 106 can send operations parameters of the engine 108, torque converter 110 and/or transmission system 112 to the remote device.

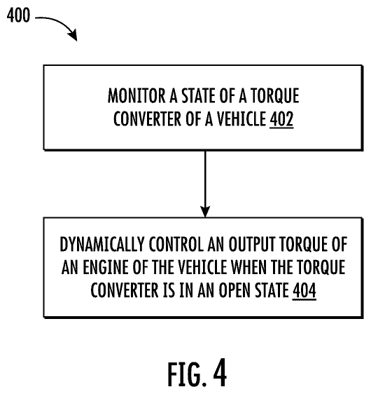

Referring now to FIG. 4, a flow diagram illustrating a method 400 of dynamically controlling engine torque to achieve better torque converter matching is shown, according to an example embodiment. The method 400 can include monitoring a state of the torque converter 110 of the vehicle 100 (STEP 402), and dynamically controlling an output torque of the engine 108 when the torque converter 110 is in an open state (STEP 404).

The method 400 can include the controller 106 or processor 304 monitoring the state of the torque converter 110 of the vehicle 100 (STEP 402). The controller 106 can be structured to receive indications, e.g., from a clutch sensor of the torque converter 110, of switching between the open state and the closed state of the torque converter 110. In some implementations, the clutch sensor can be configured to send indications of closing or opening events of the clutch each time the clutch closes or opens. The indication can be a binary number, e.g., 1 means switching to open state and 0 means switching to closed state.

Monitoring the state of the torque converter 110 can include monitoring other operating parameters of the torque converter 110, especially when the torque converter is in the open state. For example, the controller 106 can be structured to monitor the SR of the torque converter 110 in real time. In some implementations, an impeller speed sensor and a turbine speed sensor can periodically send measurements of the impeller speed and the turbine speed, respectively, to the controller 106. The controller 106 can use both speeds to determine the SR of the torque converter, e.g., by dividing the turbine speed by the impeller speed. In some implementations, the torque converter 110 can include an electronic circuit coupled to the impeller speed sensor and the turbine speed sensor. The electronic circuit can periodically receive measurements of the impeller speed and the turbine speed form the impeller speed sensor and the turbine speed sensor, respectively. For each pair of measurements of the impeller speed and the turbine speed, the electronic circuit can determine or compute a corresponding SR and send the computed SR to the controller 106.

In some implementations, the method 400 can include the controller 106 controlling one or more operating parameters of the engine 108. For example, the controller 106 can be structured or configured to periodically receive measurements of the engine speed from a speed sensor of the engine 108. The controller 106 may be structured or configured to receive measurements from a throttle position sensor indicative of positions of the engine throttle over time. For example, the throttle position sensor can send the indications of the throttle position on a periodic basis or responsive to changes in the throttle position.

The method 400 can include the controller 106 or processor 304 dynamically controlling an output torque of the engine 108 when the torque converter 110 is in an open state (STEP 404). The controller 106 can dynamically control the engine torque, when the torque converter is in an open state, in a way to ensure that the engine torque at a predefined speed ratio, e.g., 0.8 SR, of the torque converter 110 is smaller than or equal to a maximum torque allowed by the torque converter 110 at the predefined speed ratio. The controller 106 can dynamically control the engine torque in various ways.

In some implementations, the controller 106 can dynamically control the engine torque by controlling the engine to maintain a substantially constant engine power. In some implementations, the substantially constant engine power is substantially equal to a power value corresponding to a maximum torque allowed by the torque converter 110 at the predefined speed ratio, e.g., at 0.8 SR, and at governed engine speed. For example, the controller 106 can determine the amount of torque τ that the torque converter 110 can absorb at 0.8 SR and at the governed speed of the engine 108. The controller 106 may determine the torque τ using the 0.8 SR torque absorption curve of the torque converter 110 and the governed speed of the engine 108. The controller 106 can determine or compute the engine power needed to generate that amount of torque τ at the governed speed of the engine 108. In some implementations, the controller 106 can determine or compute the engine power needed to generate a torque that is substantially equal to (or slightly smaller than) the torque τ, e.g., a torque between τ and 0.98 τ, between τ and 0.95 τ, or between τ and 0.9 τ at the governed speed of the engine 108. The controller 106 can then control the fuel flow into the engine 108 to maintain a constant engine power equal to the computed power.

The controller 106 can regulate or control fuel flow to the engine 108 to maintain constant (or approximately constant) engine power. The controller 106 can periodically receive measurements of the throttle position in real time (or near real time). The controller 106 can repeatedly or periodically receive measurements of the engine power from a sensor or other component of the engine 108. In some implementations, the controller 106 can repeatedly or periodically compute engine power values using measurements received from various sensors. The controller 106 can compare the received or computed engine power values to the intended or constant engine power value and determine how to adjust the throttle position based on the comparison. For example, if the computed or received engine power value is smaller than the intended or constant engine power value, the controller 106 can cause, e.g., by sending instructions to the fuel system) or an actuator thereof, to allow for more fuel to flow to the engine 108 (e.g., by changing a throttle position by the fuel system or the actuator thereof). If the computed or received engine power value is smaller than the intended or constant engine power value, the controller 106 can cause, e.g., by sending instructions to the fuel system or the actuator thereof, to allow for less fuel to flow to the engine 108. In some implementations, the controller 106 may maintain constant fueling to the engine 108 when the torque converter 110 is in the open state. It is to be noted that due to tolerance errors of the sensors or other components of the engine 108 and/or torque converter 110, the engine power may still vary by small fractions, e.g., within 1%, 2% or 5% of the intended engine power.

In some implementations, the controller 106 can dynamically control the engine torque by regulating the output torque of the engine 108 as a function of a speed ratio of the torque converter 110 across a full speed ratio spectrum of the torque converter. In some implementations, data indicative of the predefined function can be stored in the memory device 306. In some implementations, the function of the SR of the torque converter 110 can have a torque value substantially equal to the torque τ (e.g., torque absorbed by the torque converter at 0.8 SR and at the governed speed ratio) representing the maximum torque allowed by the torque converter at the predefined speed ratio and at the governed engine speed. In other words, the function of the SR can be configured or defined to pass through (or slightly) below the torque absorption value of the torque converter 110 at 0.8 SR and at governed engine speed.

The controller 106 can be structured or configured to dynamically control the engine torque by dynamically controlling the fuel flow to the engine 108. The controller 106 can determine for each torque value of the function a corresponding fueling command. The controller 106 can use a data structure, e.g., a lookup table, to determine the fueling command for each possible torque value of the function. For example, the fueling command can be determined or computed offline and stored in the memory device 306. In some implementations, the controller 106 can determine the fueling command on the fly based on measurements received from various sensors and/or the engine power needed to generate the corresponding torque value. In some implementations, the function of SR defining the dynamic engine torque can be a linear function.

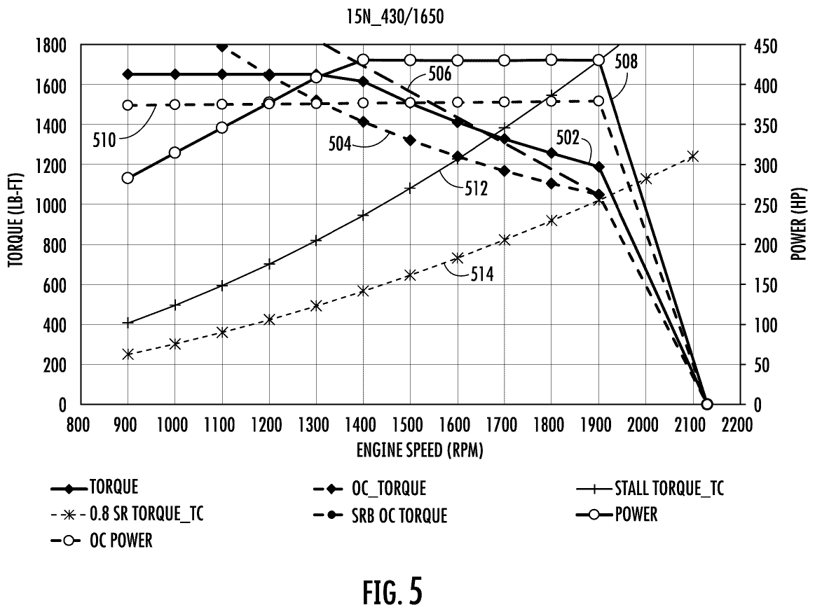

Referring now to FIG. 5, example engine torque curves for dynamically controlling the engine torque are shown, according to example embodiments. Curve 502 represents the torque characteristics of the engine 108 without dynamic control. The curve 502 can be viewed as the engine torque curve when the torque converter is the closed state. Curve 504 represents a dynamically controlled engine torque corresponding to a constant engine power. Curve 506 represents a dynamically controlled engine torque defined as a function of the SR of the torque converter 110. In this case, the curve 506 represents a linear function. Curve 508 represents the engine power corresponding to the torque curve 502 while curve 510 represents the engine power corresponding to the torque curve 504. Curve 512 and curve 514 represent torque absorption curves of a torque converter of a given type (similar to the one referred to FIG. 2) at stall and 0.8 SR, respectively.

As shown in FIG. 2, both torque curves 504 and 506 pass through the absorption torque of the torque converter 110 at 0.8 SR and at engine governed speed. The dynamic control of the engine torque allows for setting the engine torque to be equal to (or slightly smaller than) the absorption torque of the torque converter 110 at 0.8 SR and at engine governed speed, e.g., 1900 rpm, instead of being much smaller. As a result, the dynamic control of the engine torque allows for better matching (or relatively lighter torque controller matching) than conventional matching approaches. Both approaches for dynamic control of the engine torque, when the torque converter 110 is open, enhance efficiency, improve drivability and avoid or mitigate reduction of stall gradeability and degradation the engines off-idle acceleration.

Also, it is to be noted that the SR-based control of the engine torque can maximize the launch performance characteristics (stall turbine torque, stall gradeability etc.) of the vehicle 100 more than the constant power approach. Once the torque converter 110 closes (locks-up) the full output torque would be available across the entire operating speed range of the engine thereby delivering improved levels of performance during both open and closed modes of converter operation.

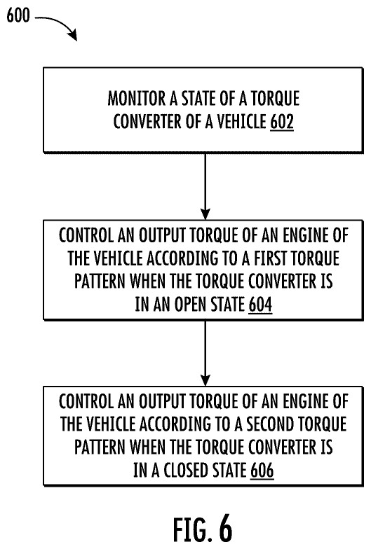

Referring now to FIG. 6, a flow diagram of another method 600 for controlling engine torque to achieve better torque converter matching is shown, according to an example embodiment. The method 600 can include monitoring a state of a torque converter of a vehicle (STEP 602), controlling an output torque of an engine of the vehicle according to a first torque pattern when the torque converter 110 is in an open state (STEP 604), and controlling the output torque of the engine 108 of the vehicle 100 according to a second torque pattern when the torque converter 110 is in closed state, the second torque pattern is different from the first torque pattern (STEP 606).

The method 600 can include the controller 106 monitoring the state of the torque converter 110 of the vehicle 100 (STEP 602). In some implementations, the controller 106 or processor 304 can be structured or configured to monitor the state of the torque converter 110. The controller 106 can monitor the state of the torque converter 110 as discussed above in relation with STEP 402 of FIG. 4.

The method 600 can include the controller 106 controlling the engine torque of the engine 108 according to a first torque pattern (or first torque curve) when the torque converter 110 is in the open state (STEP 604), and controlling the engine torque according to the second torque pattern when the torque converter is in the closed state, such that the second torque pattern is different from the first torque pattern (STEP 606). In some implementations, the controller 106 or processor 304 can be structured or configured to store or maintain data structures indicative of the first engine torque pattern (or first engine torque curve) and the second engine torque pattern (or second engine torque curve). Upon detecting that the torque converter 110 is in the open state, the controller 106 can cause the engine 108 to operate according to the first torque curve (or first torque pattern) and upon detecting that the torque converter 110 is in the closed state, the controller 106 can cause the engine 108 to operate according to the second torque curve (or second torque pattern).

The first and second torque curves may be defined as functions of (or dependent on) engine speed. In other words, the engine torque does not on the torque converter SR or the engine power as is the case for method 400 of FIG. 4. Instead, the engine 108 can generate the torques specified in the first and second torque curves as a function of engine speed. The first and second torques curves can be defined offline in a way to improve torque converter matching, increase efficiency and enhance driving experience.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed:

1. A method comprising:
monitoring, by a processor, a state of a torque converter of a vehicle; and
dynamically controlling, by the processor, an output torque of an engine of the vehicle when the torque converter is in an open state, such that the output torque of the engine at a predefined speed ratio of the torque converter is smaller than or equal to a maximum torque allowed by the torque converter at the predefined speed ratio.

2. The method of claim 1, wherein the predefined speed ratio is equal to 0.8.

3. The method of claim 1, wherein dynamically controlling the output torque of the engine includes controlling the engine to maintain a substantially constant power of the engine.

4. The method of claim 3, wherein the substantially constant power of the engine is substantially equal to a power value corresponding to a maximum torque allowed by the torque converter at the predefined speed ratio and at governed engine speed.

5. The method of claim 1, wherein dynamically controlling the output torque of the engine includes regulating the output torque of the engine as a function of a speed ratio of the torque converter across a full or substantially full speed ratio spectrum of the torque converter.

6. The method of claim 5, wherein the function of the speed ratio of the torque converter is a linear function.

7. The method of claim 5, wherein the function of the speed ratio of the torque converter has a torque value at the predefined speed ratio that is substantially equal to a maximum torque allowed by the torque converter at the predefined speed ratio and at governed engine speed.

8. The method of claim 1, wherein dynamically controlling the output torque of the engine includes controlling fuel flow to the engine.

9. A system, comprising:
a controller including one or more processors and a memory storing executable instructions, the executable instructions when executed by the one or more processors, cause the controller to:
monitor a state of a torque converter of a vehicle; and
control an output torque of an engine of the vehicle, when the torque converter is in an open state, such that the output torque of the engine at a predefined speed ratio of the torque converter is smaller than or equal to a maximum torque allowed by the torque converter at the predefined speed ratio.

10. The system of claim 9, wherein the predefined speed ratio is equal to 0.8.

11. The system of claim 9, wherein the output torque of the engine is dynamically controlled, and the executable instructions, when executed by the one or more processors, further cause the controller to control the engine to maintain a substantially constant power of the engine.

12. The system of claim 11, wherein the substantially constant power of the engine is substantially equal to a maximum power value corresponding to a torque allowed by the torque converter at the predefined speed ratio and at governed engine speed.

13. The system of claim 9, wherein the output torque of the engine is dynamically controlled, and the executable instructions, when executed by the one or more processors, further cause the controller to regulate the output torque of the engine as a function of a speed ratio of the torque converter across a full or substantially full speed ratio spectrum of the torque converter.

14. The system of claim 13, wherein the function of the speed ratio of the torque converter is a linear function.

15. The system of claim 13, wherein the function of the speed ratio of the torque converter has a torque value, at the predefined speed ratio, that is substantially equal to a maximum torque allowed by the torque converter at the predefined speed ratio and at governed engine speed.

16. The system of claim 9, wherein the output torque of the engine is dynamically controlled, and the controller is configured to control fuel flow to the engine.

17. The system of claim 9, wherein:
the output torque of the engine is controlled according to a first torque pattern when the torque converter is in the open state; and
the executable instructions, when executed by the one or more processors, further cause the controller to control the output torque of the engine according to a second torque pattern when the torque converter is in a closed state, the second torque pattern different from the first torque pattern.

18. A method comprising:
monitoring, by a processor, a state of a torque converter of a vehicle;
controlling, by the processor, an output torque of an engine of the vehicle according to a first torque pattern when the torque converter is in an open state; and
controlling, by the processor, the output torque of the engine of the vehicle according to a second torque pattern when the torque converter is in closed state, the second torque pattern is different from the first torque pattern.

19. The method of claim 18, wherein controlling the output torque of the engine according to the first torque pattern includes causing the output torque of the engine at a predefined speed ratio of the torque converter to be smaller than or equal to a maximum torque allowed by the torque converter at the predefined speed ratio.

20. The method of claim 18, further comprising:
storing, by the processor, data structures indicative of the first torque pattern and the second torque pattern.
